(19) United States
(12) Patent Application Publication
(10) Pub. No.: US 2016/0100110 A1
(43) Pub. Date: Apr. 7, 2016

(54) Apparatus, Method And Computer Program Product For Scene Synthesis

(71) Applicant: Nokia Technologies Oy, Espoo (FI)

(72) Inventors: Sujeet Shyamsundar Mate, Tampere (FI); Sakari Alenius, Lempaala (FI)

(21) Appl. No.: 14/873,432

(22) Filed: Oct. 2, 2015

(30) Foreign Application Priority Data
Oct. 2, 2014 (GB) 1417399.1

(51) Int. Cl. H04N 5/262; G06T 5/50; G06K 9/00; G06T 7/00; H04N 5/232; H04N 5/247

(52) U.S. Cl. CPC H04N 5/2624; H04N 5/23238; H04N 5/247; H04N 5/23206; G06K 9/00624; G06T 7/0042; G06T 5/50; G06T 2207/20221; G06T 2207/30244; G06T 2207/10016

(57) ABSTRACT

There is provided methods, apparatuses and computer program products for obtaining a media presentation as a seed media; and obtaining one or more criteria for content extraction. Information relating to media presentations among a set of media presentations is examined to find out relevance information regarding the context and/or content of the media presentations by using the seed media and the one or more criteria. On the basis of the examination, one or more media presentations among the set of media presentations corresponding with the one or more criteria are extracted.

### TECHNICAL FIELD

The present invention relates to relates to user generated content capture and enhancement. The invention further relates to an apparatus and a computer program product for processing captured media to obtain a processed media representation.

### BACKGROUND INFORMATION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Cameras are often used to capture images and/or video in many events and locations users visit. There may also be some other users nearby capturing images and/or video in the same event but from a different view point. The images and videos can be uploaded to a server in a network, such as the internet, to be available for downloading by other users. When one plays back the video s/he might also want to see images and/or videos captured by others during the event, or s/he might want to obtain other information relating to the event and/or person(s) visible in the video(s). Users may wish, for example, to seek alternative view points, alternate tracks, alternate edits and alternate media even during playback or rendering of media.

It may happen that although there is plurality of cameras, either end user and/or professional cameras, capturing content in an event, the captured views do not always include all the relevant parts of the scene in a single camera's views. For example, in a picture A taken by a camera at time T1, objects of interest (OOI) M and N appear but other one or more objects of interest that were in the vicinity at the same time are missed. Similarly, in a picture B taken by another camera at time T1, objects of interest N and K appear but other one or more objects of interest are missed.

Furthermore, end user content capture equipment may not allow capture of content at very high quality, or due to a non-optimum location of the capture equipment light conditions and audio may not be optimal. It may also happen, especially in case of big events when the network usually is congested that sharing of high quality content may be quite difficult or even impossible.

In general field of view as well as capture resolution capabilities of dedicated professional content capture equipment have increased. The trend is towards bigger and more cameras that cover events. However, the content quality at capture and/or sharing time is the quality of content that can be consumed or viewed by the users who watch the personally generated videos.

Image Panorama is a process in which multiple pictures with a different viewing angle taken by the same user in sequence are combined to produce a panorama. However, it may not be common for users to capture panoramas for each picture, since it does not always have the necessary detail and secondly, it may not be a good user experience to expect the user to capture each scene as a panorama.

### SUMMARY

This invention is related to providing a way to perform scene synthesis and media amplification on the basis of one or more recorded media content. One intention is to generate new scenes of an event by combining plurality of contributed content captured in the same event.

Some embodiments deal with methods for utilizing professional quality content for creating personalized web syndication streams. This may be performed by obtaining a media presentation as a seed media; obtaining one or more criteria for content extraction; examining information relating to media presentations among a set of media presentations to find out relevance information regarding the context of the media presentations by using the seed media and the one or more criteria; and on the basis of the examination, extracting one or more media presentations among the set of media presentations the contents of which correspond with the one or more criteria.

According to a first aspect of the invention, there is provided a method comprising:
obtaining a media presentation as a seed media;
obtaining one or more criteria for content extraction;
examining information relating to media presentations among a set of media presentations to find out relevance information regarding the context and/or content of the media presentations by using the seed media and the one or more criteria; and
on the basis of the examination, extracting one or more media presentations among the set of media presentations corresponding with the one or more criteria.

According to a second aspect of the invention, there is provided an apparatus comprising at least one processor and at least one memory including computer program code, the at least one memory and the computer program code configured to, with the at least one processor, cause the apparatus to perform at least the following:
obtain a media presentation as a seed media;
obtain one or more criteria for content extraction;
examine information relating to media presentations among a set of media presentations to find out relevance information regarding the context and/or content of the media presentations by using the seed media and the one or more criteria; and
on the basis of the examination, extract one or more media presentations among the set of media presentations corresponding with the one or more criteria.

According to a third aspect of the invention, there is provided a computer program product including one or more sequences of one or more instructions which, when executed by one or more processors, cause an apparatus to perform at least the following:
obtain a media presentation as a seed media;
obtain one or more criteria for content extraction;
examine information relating to media presentations among a set of media presentations to find out relevance information regarding the context and/or content of the media presentations by using the seed media and the one or more criteria; and
on the basis of the examination, extract one or more media presentations among the set of media presentations corresponding with the one or more criteria.

According to a fourth aspect of the invention, there is provided an apparatus comprising:
means for obtaining a media presentation as a seed media;
means for obtaining one or more criteria for content extraction;
means for examining information relating to media presentations among a set of media presentations to find out relevance information regarding the context and/or content of the media presentations by using the seed media and the one or more criteria; and
means for extracting, on the basis of the examination, one or more media presentations among the set of media presentations corresponding with the one or more criteria.

Some embodiments provide tools for using end user generated content as a seed to leverage better quality content as well as user generated content to create a new scene representation or generate a higher quality scene representation that closely matches the intentions of the person who has captured the seed media.

In an embodiment a same temporal instance or a temporal period captured by different users may be used to extract relevant parts of individual captures to generate a synthesized scene.

New views and/or experiences may also be generated by combining content from multiple users. It may also be possible to utilize user provided seed media to build a synthesized view around it, thus improving relevance of the media.

In the construction of new views it may be possible to utilize some sensor data to minimize content analysis.

Some embodiments allow users to record content from their mobile devices with mediocre content capture capabilities but still enable sharing high quality media that represents their narration of the event. Therefore, it may be possible to combine the individuality of an end user recorded content while providing professional quality content to be shared in social networks after the recording or in real-time.

The problem of sharing high quality content may be addressed by allowing the user to upload only a representative low quality content stream to a MAS server.

Some embodiments also allow professional content creators to utilize their content by more users and for longer periods inter alia since the sharing of lower quality end user generated content may continue for many days after the event.

Some embodiments provide the possibility for personalized web syndication of events by utilizing professionally captured content.

### DESCRIPTION OF THE DRAWINGS

In the following, various embodiments of the invention will be described in more detail with reference to the appended drawings, in which

FIG. 1 shows a block diagram of an apparatus according to an example embodiment;

FIG. 2 shows an apparatus according to an example embodiment;

FIG. 3 shows an example of an arrangement for wireless communication comprising a plurality of apparatuses, networks and network elements;

FIG. 4 shows a block diagram of an apparatus usable as a user device according to an example embodiment;

FIG. 5 shows a block diagram of an apparatus usable as a server according to an example embodiment;

FIG. 6 shows an example situation in which some embodiments may be used;

FIGS. 7a and 7b show examples of venues in which a panoramic recording system may be utilized;

FIG. 8a illustrates a situation in which some spectators are recording video or multimedia of an event by using their own capturing devices;

FIG. 8b illustrates how a pose and direction of view of an image sensor of a capturing device may be obtained on the basis of information on the location, compass orientation and tilt;

FIG. 9 illustrates an example on how to find out which camera of a video recording system of an event may have the best correspondence regarding the pose of a user's capturing device;

FIG. 10 depicts an example of a user interface for a synthesized scene service;

FIG. 11 illustrates an example of a technical implementation in which a method according to an example embodiment may be applied;

FIGS. 12a-12c show examples of captured images;

FIGS. 12d-12f show examples of synthesized images;

FIG. 13 shows an example of a technical implementation in which a method according to another example embodiment may be applied; and

FIG. 14 shows a flow diagram of an example of finding out the camera which may have the best correspondence regarding the pose of the user's capturing device.

### DETAILED DESCRIPTION OF SOME EXAMPLE EMBODIMENTS

In the following, several embodiments of the invention will be described in the context of media files and wireless communication. It is to be noted, however, that the invention is not limited to media files and wireless communication. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In some events a high resolution wide field of view video recording system may be utilized which allows for the capture of the whole event with 360 degrees coverage. This kind of system may be called as a panoramic recording system (PRS). The system may comprise a plurality of high resolution large field of view cameras that cover the whole event venue or it may comprise a multiple of camera arrays that cover the whole event venue. The panoramic recording system may also comprise multiple cameras that cover the same field of view but with different depths of field to facilitate desirable coverage at different depths w.r.t to the camera positions of the panoramic recording system.

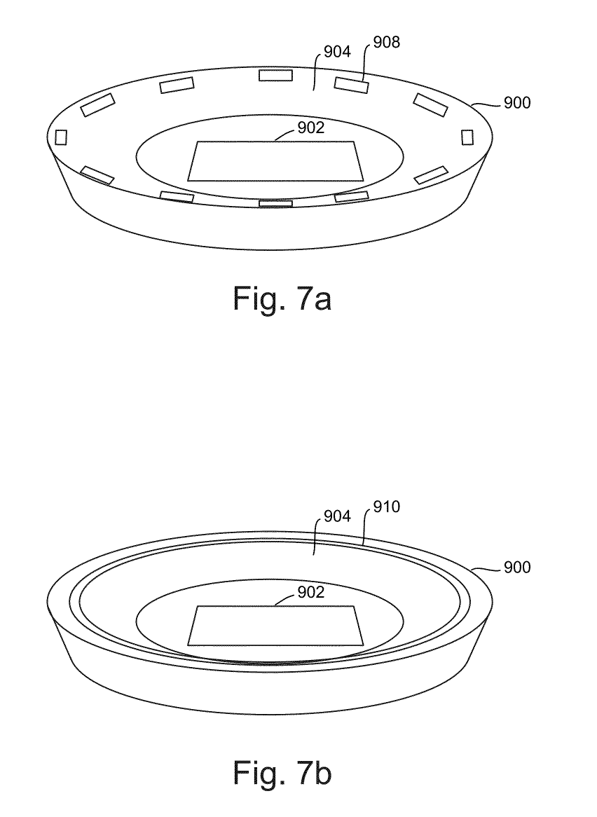

An example of a venue in which such panoramic recording system may be utilized is illustrated in FIGS. 7a and 7b. The venue 900 is a football stadium having a football field 902 and a spectator stand 904. In the example of FIG. 7a the panoramic recording system 906 comprises multiple cameras or camera arrays 908 so that the views of the cameras or camera arrays 908 cover the whole football field 902 all around the football field 902. In other words, the cameras or camera arrays 908 provide 360 degrees coverage on the football field 902. In the example of FIG. 7b the panoramic recording system 906 comprises a camera array 910 so that the camera array 910 is able to provide 360 degrees coverage on the football field 902. It should be noted that these two examples are only clarifying the idea of the panoramic recording system but the system is also applicable in other venues both outdoors and indoors.

If the panoramic recording system 906 is able to provide full coverage of the event venue, it may enable video amplification coverage to the whole event venue. In an embodiment, the panoramic recording system 906 may comprise of substantially complete coverage if not full 100% coverage. The cameras of the panoramic recording system 906 may be able to communicate with a server via a communication connection which is able to transfer high quality media streams from these cameras. For example, one or more of the contribution camera sources are connected to the panoramic recording system 906 with a high speed data link to ensure fast and reliable enough content delivery of massive video data generated by the plurality of high quality cameras.

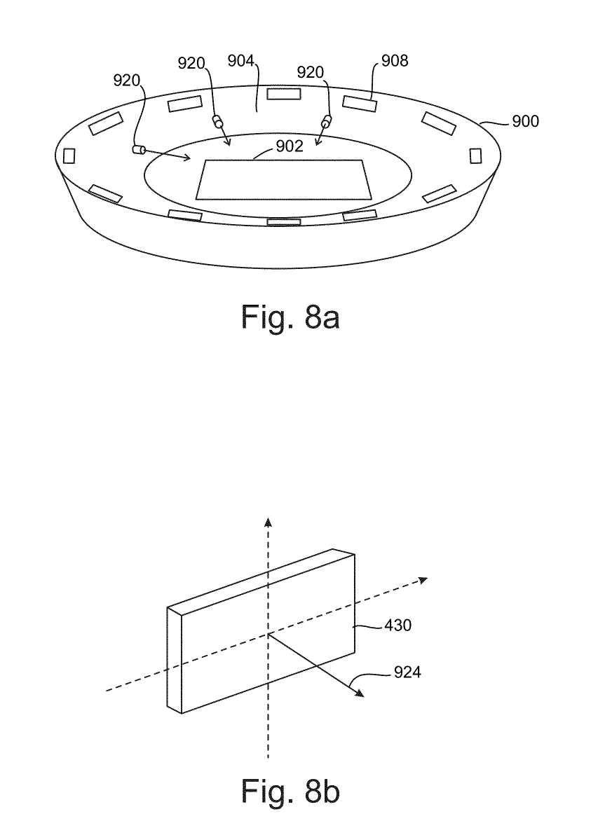

FIG. 8a illustrates a situation in which some spectators (end users) are recording video or multimedia of the event by using their own capturing devices 920, such as mobile communication devices. They are located at different locations wherein each capturing device 920 has a different view to the event. The capturing devices 920 are provided with means to obtain some device specific information on a geographical location, a position (a pose), a compass orientation, a direction of the view, a tilting angle, temperature, time and/or some other information which may be useful in content capture generation and enhancement. The device specific information may be attached with the captured information e.g. as metadata and may be stored into a memory of the capturing device 920. Instead of or in addition to storing the metadata and/or the captured information into the memory of the capturing device 920 they may be communicated to, for example, a server 130 of a media amplification system 100 for storing and further processing.

FIG. 8b illustrates how the pose and the direction of view of an image sensor 430 of the capturing device 920 may be obtained on the basis of information on the location, compass orientation and tilt. The location indicates the spot where the capturing device 920 is in the venue. The location may be an absolute spatial location (geographical coordinates) or it may be a relative spatial location with respect to a reference location. Compass direction and tilt indicate the direction of view of the image sensor 430 which may be represented as a normal vector 924 with respect to the plane of the image sensor 430.

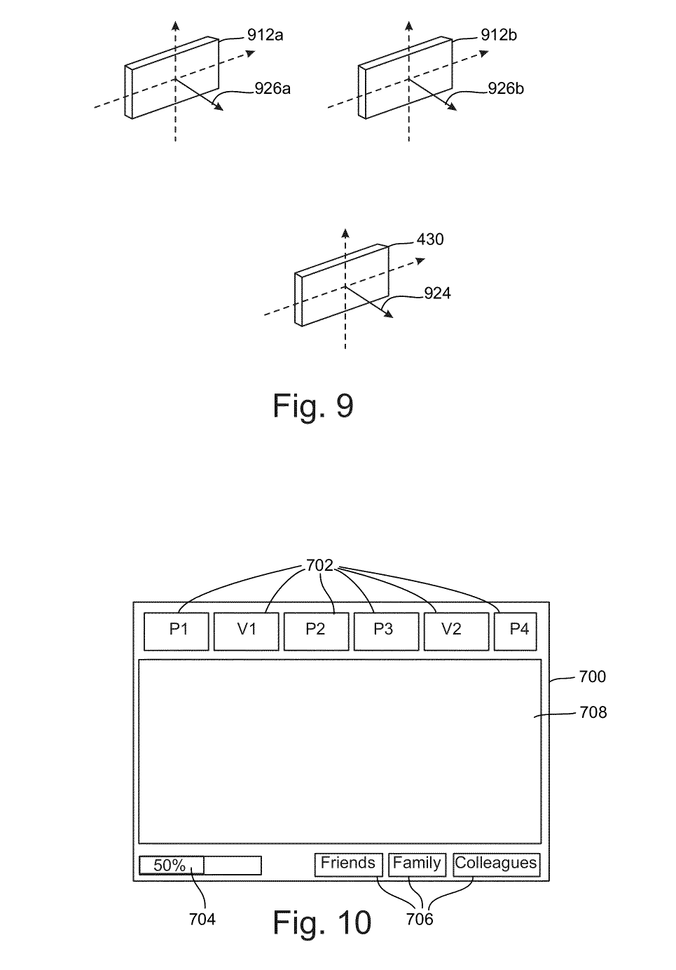

FIG. 9 illustrates how it may be possible to find out which camera of the video recording system 906 of the event may have the best correspondence regarding the pose of the user's capturing device 920. In this illustration only two cameras 912a, 912b of the video recording system 906 and their camera pose estimates 926a, 926b are shown but in practical situations there may be more than two cameras available. A camera pose estimate Pᵢ for one or more cameras of the video recording system 906 may be obtained and this information may be used to select the camera which has the best pose estimate with respect to the pose Eₙ of the user's capturing device 920. It may not be necessary to obtain the camera pose estimate Pᵢ for each camera of the video recording system 906 but some criteria may be used to define a subset of cameras which are located near the user's capturing device 920 and obtaining the camera pose estimate Pᵢ for the cameras of the subset.

FIG. 14 shows a flow diagram of an example of finding out the camera which may have the best correspondence regarding the pose of the user's capturing device 920. In step 1400 the processor 502 may receive information which may be used to estimate a pose Eₙ of the user's capturing device 920. This information may comprise location coordinates, compass direction, skew, tilt and/or azimuth of the user's capturing device 920. Additionally, or instead of, the information may comprise captured media and temporal information regarding the captured media, wherein the content of the captured media may be used in the finding process. The processor 502 may then estimate 1402 the pose Eₙ of the user's capturing device 920.

The processor 502 may also receive 1404 information which may be used to estimate a pose Pᵢ of one or more media captured by one or more cameras 912a, 912b of the video recording system 906. Correspondingly, this information may comprise location coordinates, compass direction, skew, tilt and/or azimuth of the cameras 921a, 921b and/or captured media and temporal information regarding the captured media. The processor 502 may then estimate 1406 the pose Pᵢ of the cameras 912a, 912b of the video recording system 906.

The processor 502 may compare 1408 the estimated pose Eₙ of the user's capturing device 920 with the estimated pose Eₙ of the cameras 912a, 912b of the video recording system 906.

The result of the comparison may indicate 1410 if the estimated pose Pᵢ of the camera of the video recording system 906 under examination has good enough correspondence with the pose of the pose Eₙ of the user's capturing device 920. If the comparison uses location coordinates, compass direction, skew, tilt and/or azimuth, the correspondence may be found when the corresponding location coordinates, compass direction, skew, tilt and/or azimuth of a camera 912a, 912b of the video recording system 906 differ less than a predetermined threshold from the end user's device 920.

It may also be possible to use content of media captured by cameras 912a, 912b of the video recording system 906 and compare it with the content of media captured by the end user's device 920. Hence, the media captured by a camera 912a, 912b of the video recording system 906 which has the most similar content may indicate that the corresponding camera may provide the most corresponding pose.

The comparison may be repeated 1412 until a camera of the video recording system 906 has been found which provides good enough correspondence with the pose of the pose Eₙ of the user's capturing device 920 or until all the estimated poses of the cameras 912a, 912b of the video recording system 906 have been examined.

### Scene Synthesis

According to one aspect there is provided a method and apparatus for synthesizing a scene by extracting and combining one or more spatially and temporally relevant parts from one or more content captured in a common event. The captured content may be e.g. professionally captured content and/or end user captured content.

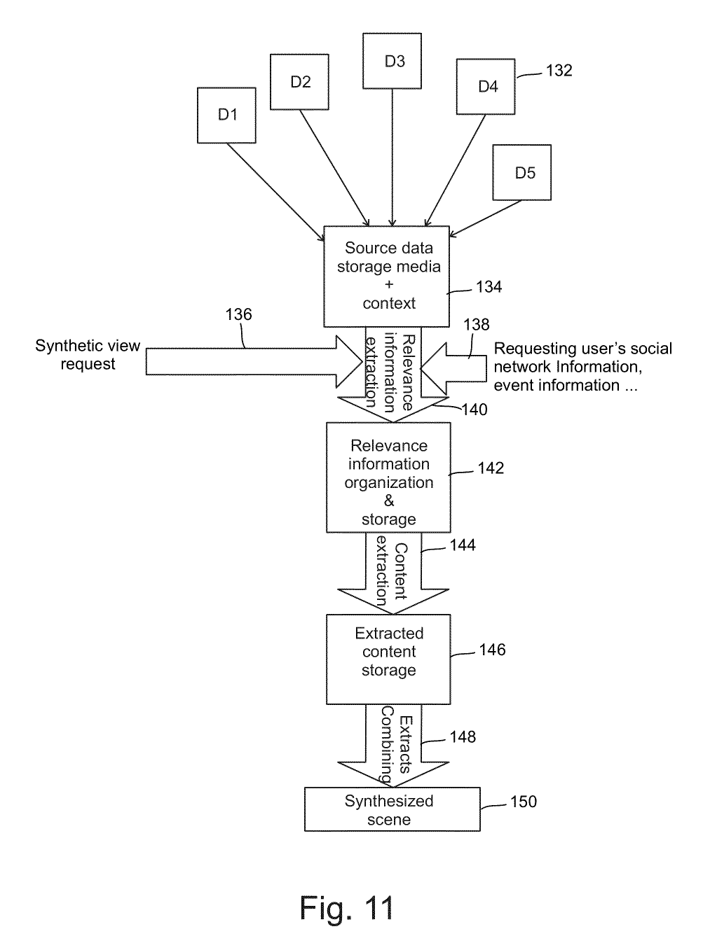

FIG. 11 illustrates an example of a technical implementation in which the method may be applied. The system may be based on e.g. a so-called client-server solution or a peer-to-peer solution architecture. Without loss of generality, client-server solution is explained in more detail in the following.

There may be a plurality of capturing devices (D1 to D5) which may be end user capturing devices 920 or capturing devices 908, 910 which are able to produce media streams which have higher quality than the end user capturing devices 920. Such devices may also be called as higher quality capturing devices in this specification. The higher quality capturing devices may also be called as professional cameras, although some existing end user capturing devices may already be able to capture media streams with quite a high quality.

The end user capturing devices 920 may comprise one or more sensors 432 for measuring information regarding the end user capturing device and/or the environment in which the end user capturing devices are in use. For example. the end user capturing device(s) 920 may be mobile devices with cameras 430 and sensors 432. The end user capturing devices 920 may be able to provide captured content and associated context data as well as sensor data to the media server 130. The context and sensor data may be time stamped to match the content time line.

When the capturing devices are capturing media such as video and/or audio information, they may also use sensor information, time information and/or other information available to the capturing devices and attach that information with the captured media. For example, a capturing device may comprise a compass, a positioning device, a gyroscope, a temperature sensor, a clock, and/or some other sensors. wherein the capturing device may use that information and attach it to the captured media. Instead of or in addition to the sensors of the capturing device external sensor information may be available to the capturing device, wherein the capturing device may use that externally available information and attach it to the captured media. Blocks 132 in FIG. 11 illustrate some capturing devices.

In an embodiment, the content may also be captured using a panoramic recording system or some other capturing system of an event.

Media streams captured by the capturing devices and possible sensor and/or context data may be transmitted to a media server 130 which may store the received media streams or parts of them into a source data storage associated with sensor and/or context data. This is depicted with block 134 in FIG. 11.

When a user may wish to synthesize a scene s/he may select a seed media and one or more preferences to be used in the synthesis. A synthetic view request 136 may be transmitted to the media server 130. The request may include an identifier of the seed media (e.g. a seed media ID), and a time instance of the seed media or a relevant part of the seed media. The request may also include information on how long the synthesized scene should last. The request may further be included with information on the requester's social network identifier and/or a preference template. The preference template may indicate some further information for relevance information extraction.

The media server 130 may then request 138 user's social network information, if it is not provided with the request, event information the user is attending, etc. This information may be provided by the user by using her/his capturing device or it may be obtained otherwise.

In an embodiment the event may be identified e.g. by using information the user may have entered into a calendar application. Hence, if the capturing time is within the time specified by an event in the user's calendar application, that event may be used. Another option to determine the event without user's interaction is to use location information obtained e.g. by the capturing device and searching an event database which event may take place at that particular place at that particular time.

The user's calendar information may also be used to determine whether the event is related to the user's private life or profession. Hence, the result of the determination may be used as a parameter to define which contacts in the user's contact database may be used as a preference. As an example, if the event the user is attending relates to her/his private life (leisure time), the relevant contacts may be those contacts which are marked as friends. On the other hand, if the event the user is attending relates to her/his profession (a job related event), the relevant contacts may be those contacts which are marked as colleagues, clients, etc.

Stored media and context data may be examined e.g. by a relevance information extraction element 140 of the media server 130 to find out some relevance information regarding the context. The relevance information extraction module 140 may use e.g. one or more of the following inputs to analyse the available media, sensor and context data to generate the relevance information.
Seed media identifier (ID)
Time instance and duration of the seed media (in case it is a video or audio file)
Scene synthesis duration
Social network identifier
Preference template (ex. family, colleagues, friends, etc.)

The seed media identifier may be obtained e.g. on the basis of an identity of the capturing device which has captured the seed media. Additionally, the seed media identifier may comprise a sequence number or another unique indication of the seed media.

Time instance and duration of the seed media (in case it is a video or audio file) may also be used to determine which media streams captured by the higher quality capturing device(s) relate to the same event at the substantially same time. It is probable that higher quality media streams captured much earlier or later than the seed media are not so relevant compared to media captured in the temporal vicinity with the seed media.

Scene synthesis duration indicates how long lasting the examined media is wherein it may be possible to judge which of the examined media may have higher relevance regarding the context.

Social network identifier may indicate in which social networks the user who has captured the media may belong to, wherein other media captured by another user belonging to the same social network may have higher relevance compared to media captured users not belonging to the same social network.

The scene synthesis may also be guided by one or more user defined parameters. To achieve this, the end user device may be instructed to show a preference template by which the user may enter one or more parameters which s/he wants to be used in the scene synthesis. For example, the preference template may be used to define whether the synthesised context relates to family, colleagues, friends, etc.

The one or more relevant parts may be determined using e.g. one or more of the following data associated with the captured content in the storage. The time data provided in the request may be compared with time data of captured contents to find out which captured contents have temporal overlap with the seed media within a predefined threshold. Another criteria may be the location where the content have been captured wherein position in 3D space may be compared with position data of the seed media. The position in 3D space may be an absolute location or a relative position in the given event. Also a compass orientation may provide appropriate information to determine which captured content have similar view as the device which has captured the seed media. Accelerometer information may indicate changes in the position (and the view) of the capturing device during capturing the content under examination.

The position may have been obtained by a positioning receiver such as a GPS receiver (Global Positioning System), an indoor positioning receiver, etc.

The above discussed criteria were related to the context but also content information may be used as a criterion when selecting a captured content for the scene synthesis on the basis of the seed media. For example, the captured content may include one or more objects of interest (OOI). If some of the captured contents are so called multi-view content, the criteria may be related to one or more objects of interest in one or more views of the content. In other words, an object of interest may not be visible in each view but in one or some views and still that object may be used as a criterion. One option for determining relevance information is to examine spatial position of one or more objects of interest in the content, wherein a captured content having a certain pose may provide the most appropriate scene for the synthesis. Still another option is the relative size of one or more objects of interest in the content, wherein contents having larger sized images of the objects of interest may provide a good basis for the synthesis.

The above mentioned examples of criteria are only some possibilities but also other criteria may be used in practical implementations.

The relevance information from the source content is stored and organized 142 in a manner that facilitates easy manipulation for making inferences about the more relevant parts and the less relevant parts. The content extraction element 144 extracts the relevant one or more content parts from one or more content and stores the extracts into a extracted content storage 146. One or more of the stored content extracts may be provided as an input for a extracts combining element 148 which may combine the extracts.

The relevant parts may be extracted using the above information such that the one or more objects of interest of desired prominence (ex. Ratio of the size of objects of interest w.r.t the captured frame size, contrast of the objects of interest w.r.t the background, sharpness of objects of interest w.r.t the background), desired orientation and occurring at desired time may be selected from the captured content. The extracted parts may subsequently be synthesized to generate a new scene which consists of the one or more objects of interest in a desired manner.

In an embodiment, the original source captures need not be limited to the same geographical location but can be distributed across a larger area, even across the globe. In such situations the different scenes across the larger area are logically connected. For example, a scene synthesis performed using content captures from users across the globe recording a football world cup final match in sports bars and open theatres in different parts of the world may be such logically connected captures.

In an embodiment of the invention, a seed media may be used to act as an anchor for synthesizing the scene. The seed media may be any type of media (i.e. a sensor data vector, audio, video, image, graphics, etc.). The seed media attributes comprising one or more of the following may be used to generate the synthesized scene:
One or more visual objects of interests in the seed;
One or more non-visual objects of interests in the scene;
Object of interest relevance with user's known social networks and/or previous object of interest preferences;
Position in a three dimensional (3D) space of the capturing device when the seed media was captured;
Object of interest appearance frequency;
etc.

The SEED media along with the user preferences may be signaled from the user's device to the media server 130 for generating the synthesized scene.

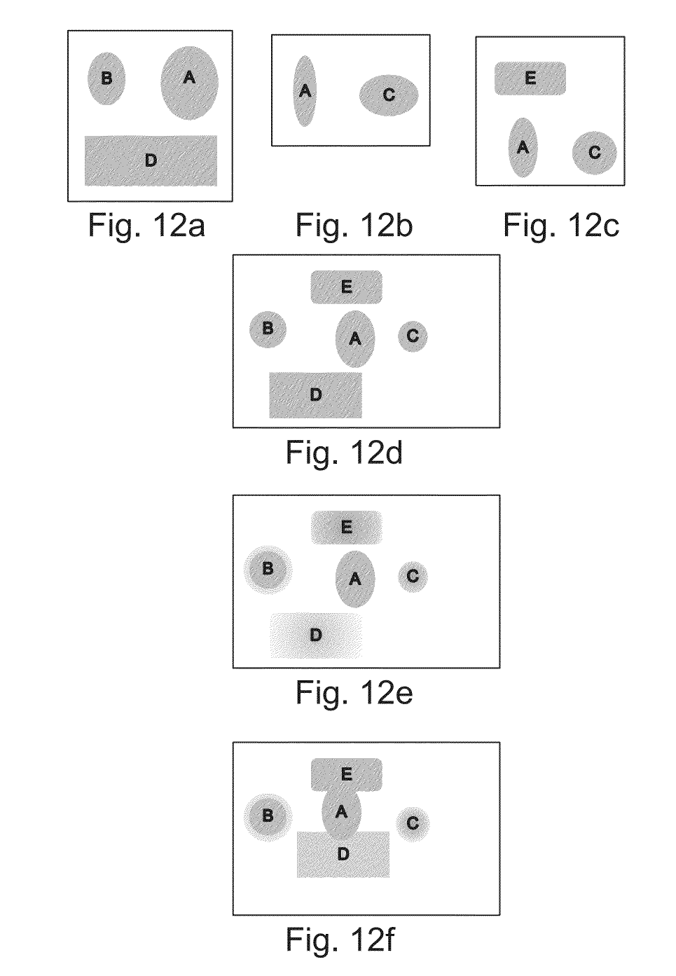

In an embodiment the extracts may be combined based on the request parameters, which may include user preferences. One option for the combining is to provide a realistic (honestly) synthesized scene. An example of this is depicted in FIG. 12d. In this example the synthesized scene is a combination of objects of interest A-E from three different captured contents 150. These three examples of captured content are illustrated in FIGS. 12a, 12b and 12c. In the captured content of FIG. 12a the objects of interest A, B and D are visible, in the captured content of FIG. 12b only the objects of interest A and C are visible, and in the captured content of FIG. 12a the objects of interest A, C and D are visible.

FIG. 12e illustrates another option for the scene synthesis. In this example the synthesized scene is based on preference template by which the user may define some criteria for the scene synthesis. For example, the user preferences for determining the object of interest may be done by using the image database from the user's social network. For example, while synthesizing a scene, faces of people appearing in the source captures that match with faces of friends/relatives/colleagues may be used prioritized based on the template or preference set activated by the user. As another example, a scene synthesis for an office function can leverage the user's professional network to prioritize appearance of office colleagues. In case of a family event like wedding, the user's friends and relatives may be prioritized for appearance in the synthesized scene. As a result, some of the objects of interest may be shown quite sharply, such as objects A and C, whereas some of the other objects may be shown more or less blurred, such as the objects B, D and E. For example, sharper objects may depict faces of people belonging to the selected user's social network, and some of the blurred objects may depict faces of people not belonging to the selected user's social network and/or they may depict other objects than peoples or people's faces.

FIG. 12f illustrates still another option for the scene synthesis. In this example an overlay synthesis is illustrated, wherein objects of interest may be depicted in an overlaid fashion i.e. an object of interest is partly overlapping with another object of interest. In the example of FIG. 12f the objects A, D and E represent objects of interest wherein they are overlaid in the synthesized scene. In other words, the one or more relevant extracted parts from one or more source content may be combined in such a way that they may overlap with each other to generate new synthesized scene which consists of one or more objects of interest in the background which is overlaid with one or more objects of interest in the foreground.

In the description above examples of objects of interest were visual objects but they also may be other kind(s) of object(s) i.e. non-visual objects. For example, a word or phrase spoken in the event may represent such an object of interest. The word or phrase may be based on its literal and/or semantic meaning. A word or phrase spoken by a particular individual may also be defined as an object of interest. In other words, when a voice of a certain person is detected, or when that person pronounces a certain word or phrase, that voice, word or phrase may be defined as an object of interest. It may also be the case that a certain type of sound has some relevance in the determination of an object of interest. Some non-limiting examples of such types of sounds are song, speech, clapping, and applause. As a still further example of a possible criterion regarding determining an object of interest may be temperature. For example, a high temperature zone may indicate that one or more objects of interest may be found near that zone, such as parts of content near a fireplace in a living room or content from near a barbeque.

An example of a user interface 700 for a synthesized scene service is illustrated in FIG. 10. The seed media selection and synthesized view or scene generation method will be explained in the following. A user of the service can choose a picture P1-P4 or a video V1, V2 and a preference template (one of which may be a default). In FIG. 10 the icons 706 illustrate three different kinds of selectable preference templates: friends, family and colleagues The selection may be indicated to the device e.g. by touching one of the icons 702 indicative of seed media selection buttons. In case of a continuous media (like video or audio) being used as the seed media, the user may adjust the slide bar 704 to indicate the percentage duration of the content to be used as the seed media. When the seed media and preferences have been selected, this information may be transmitted to the media server 130. Subsequently the service may generate the synthesized scene and send the result to the user's device. The synthesized scene may then be viewed by the user e.g. on the media viewing area 708 of the user interface and/or the synthesized scene may be stored into the memory of the device.

In another embodiment the user's device may perform the operations to synthesize the scene on the basis of the information provided by the user. In that case the device may have access to a captured content storage which may be external to the user's device. For example, the storage may be located at a server which is in a communication connection with a communication network such as the internet, wherein the user's device may also communicate with the same network to have access to the storage.

### Media Amplification

According to one aspect there is provided a method and apparatus that utilizes user captured media as a seed media to guide a scene synthesis and/or media amplification service 100 by utilizing either the content captured by a video recording system 906 of an event or a plurality of user captured content. In this specification the term media amplification means a method for obtaining a higher quality media as a response to a lower quality input media. The lower quality input media may also be referred as end-user-media or EU-media in this specification. The higher quality media so obtained is aimed to correspond a substantially matching representation of the original input lower quality media.

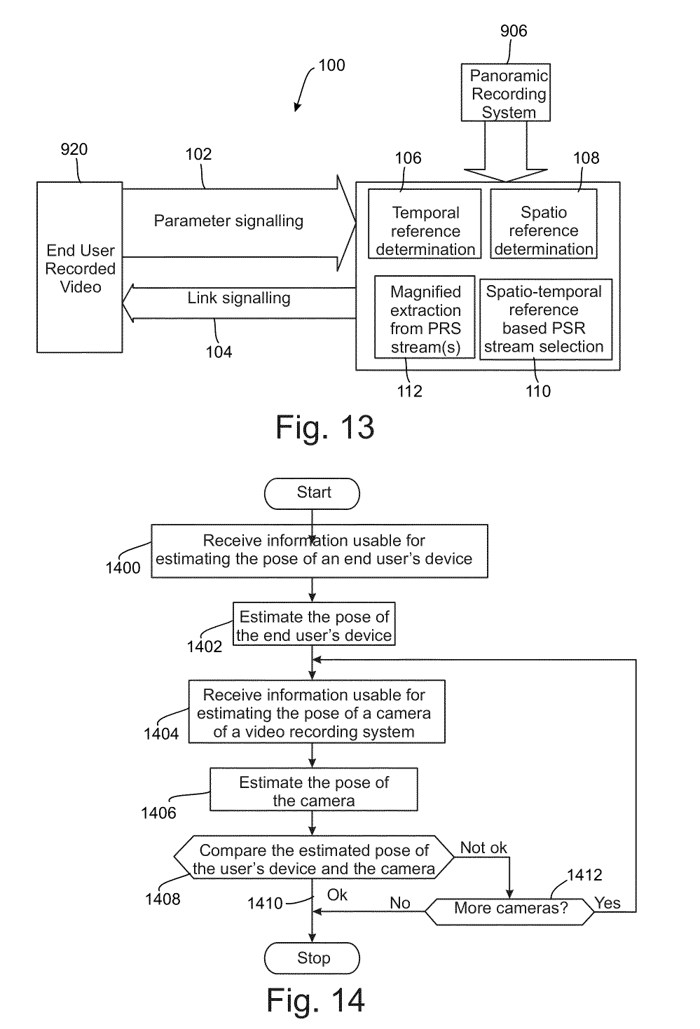

FIG. 13 presents some elements of an example implementation of the media amplification system 100. The media amplification system 100 is able to receive signalling 102 from one or more capturing devices 920 of one or more users. These devices may also be called as end user devices in this specification. Examples of signalling from the capturing devices 920 are provided later in this specification. The media amplification system 100 is also able to receive media information captured by a camera network, such as the panoramic recording system 906 of FIGS. 7a and 7b. This media may also be called as a higher quality media in this specification. Furthermore, the media amplification system 100 is able to transmit 104 information regarding extracted higher quality media to end user devices 920 and/or to other devices. The media amplification system 100 also comprises a temporal reference determination block 106 which examines the seed media and possible other information attached with the seed media and media provided by the camera network to find temporal correspondence between the seed media and media provided by the camera network. A spatial reference determination block 108 is adapted to examine the seed media and possible other information attached with the seed media and media provided by the camera network to find spatial correspondence between the seed media and media provided by the camera network. A spatio-temporal reference selection block 110 is adapted to select a reference media among the media provided by the camera network which may provide a higher quality representation of the seed media. A magnified video extraction block 112 is adapted to generate an extracted media representation on the basis of the selected reference media. Information on the extracted media representation may be output 104 from the media amplification system 100.

In the following some operations which the user may perform by the capturing device 920 to signal the media amplification system 100 criteria for the media amplification are described. Media captured by one or more capturing devices 920 is the media for which a higher quality media representation is intended to be delivered by the media amplification system 100. Signalled criteria for the media amplification may comprise, for example, low resolution recorded video. Hence, depending on the capabilities of the capturing device, either the original captured media is delivered to the media amplification system 100 or a reduced resolution and/or quality to allow transmission over a lower bandwidth, i.e. if the bandwidth of a communication connection between the capturing device 920 and the media amplification system is not broad enough for transmitting the original resolution and/or media. Instead or in addition to, the signalled criteria may comprise representative video frames. Thus, depending on capabilities of the capturing device, the capturing device may track the movements of the camera based on e.g. device's sensor(s) or content analysis methods. In an embodiment the recorded video may be transformed into a suitable representation comprising one or more features that may be more suitable for processing in the media amplification system 100.

In an embodiment the user of the capturing device 920 may be able to examine camera pose estimates of higher quality media streams and browse which angles may be available. For example, the user may send by her/his capturing device 920 a request to the media amplification system 100 to send to the capturing device 920 information on available camera poses, wherein the user may have a look at visual information provided by different cameras. Hence, the user may choose an appropriate camera pose estimate of the higher quality media stream. The choice may thus allow the user to choose e.g. a different depth of field camera stream from the higher quality media streams if so desired.

In another embodiment the user may provide only a few images as the seed media, wherein the media amplification service 100 may determine the camera pose estimate trajectory and return the most closely matching high quality media representation.

The criteria sent by the capturing device 920 may also comprise some preference data, such as audio mixing preference. This preference indicates to media amplification system 100, if the audio of the seed media should be kept as it is with only the high quality visual media added to the amplified media. The preference may also indicate if both audios i.e. the seed media audio and higher quality media audio are combined. Another example of such preference information is a depth of field preference by which the capturing device 920 may indicate the user's preference for inclusion of a hyperfocal video or a depth of field media stream that is closest to an object of interest (OOI). These preferences are only non-limiting examples but also other preferences may be signalled in addition to or instead of the audio mixing preference and/or depth of field preference.

### Media Amplification Service (MAS)

In addition to receiving the plurality of higher quality video feeds and storing them, the media amplification system 100 may also analyse the content of the received higher quality video according to appropriate criteria. Analysed higher quality media streams may also be indexed to assist fast matching with the seed media when users are requesting media amplification.

In an embodiment, the spatio-temporal references extracted based on the EU-media may be processed further to generate a more smooth non-shaky content. The post-processing may also be controlled by the user to remove certain temporal segments or use non-original content segments for some temporal intervals.

In the following the media amplification process is described in more detail with reference to FIGS. 7a to 15. The user has captured one or more still images and/or one or more videos by the capturing device 920 during an event. In addition to capturing visual information other information may also be captured, such as audio and/or sensor data. The sensor data may be obtained by using one or more sensors or other information providing elements of the capturing device 920. Some examples of device specific sensor data have been provided previously in this specification.

The captured image, video and audio and any combination of them are also called as captured media in this specification. Thus, captured media may comprise:
one or more still images;
one or more video frames;
one or more audio recordings;
one or more still images and one or more video frames;
one or more still images and one or more audio recordings;
one or more video frames and one or more audio recordings;
one or more still images, one or more video frames and one or more audio recordings.

The capturing device 920 may track the movement of the capturing device 920 e.g. by using sensor or content analysis based methods. For example, if the user turns the capturing device 920 to another direction, this may be detected by analysing information provided by a gyroscope or a compass of the capturing device 920. Another option to detect the movement is to analyse changes in captured video information during capturing. Subsequently, when a change is detected, the frames corresponding to the change in camera position in 3D-space may be chosen as a representative frame or frames. Also information of the time of change may be stored.

Captured image(s) and video(s) may be stored into a memory of the capturing device 920. It may also be possible to transmit them to a storage element external to the capturing device 920. Such storage element may be, for example, a server connected to a communication network such as the internet or a mobile communication network.

The video recording system 906 may also perform capturing still images, videos and/or audio during the event at different locations and viewpoints. Information captured by the video recording system 906 may be stored to a server, for example.

The media captured by the capturing device 920 may be used as a seed media to leverage it as a spatial and/or as a temporal guide for performing the media amplification.

When the user has decided which captured lower quality media should be represented by higher quality media the following may be performed. The user selects by the capturing device 920 the lower quality media, wherein the capturing device 920 sends information on the selected media to a server 120 of the media amplification system 100. The information may comprise video, audio, still images and/or metadata attached with the lower quality media. The information may further comprise some preference data set by the user and/or the capturing device 920. A controller 122 of the media amplification system 100 may use audio alignment, visual alignment or any suitable alignment method to determine temporal reference of the seed media with respect to the higher quality media. In other words, the controller 112 may compare audio frames of the seed media to audio frames of higher quality media to find out which audio frames of higher quality media resemble enough of audio frames of the seed media. If such a correspondence can be found, that corresponding higher quality media may be selected to represent the seed media. In case the audio scene is not common (e.g. no corresponding audio frames cannot be found), a temporal alignment may be done by using plurality of video frames for alignment. This may be performed e.g. by using visual scene matching for a plurality of video frames. In other words, visual contents of video frames or parts of the video frames of the seed media is compared with visual contents of video frames or parts of video frames of higher quality media representations to find out video frames in which the visual scene matches enough with the seed media. The visual alignment may also be based on extracting spatial reference of the seed media by trying to find out spatial coordinates in the higher quality media which match the spatial boundaries of the seed media video frames (see FIG. 9). A local camera pose estimate 924 (local-CPE) may be derived from the seed media. Subsequently the local camera pose estimate 926 of the closest matching candidate video streams from the plurality of the higher quality media is compared. The higher quality media stream that is the closest fit to the local camera pose estimate of seed media may be chosen as the source for the higher quality media representation to be extracted. In an embodiment, a series of representative images may be chosen for finding out the spatio-temporal references for extracting the high quality media representation from the higher quality media streams. When an appropriate higher quality media has been found, the extracted higher quality media may be processed to generate a video that matches the audio mixing preferences.

In an embodiment it may also be possible to use information on the capturing time of the seed media and to search such higher quality media in which the capturing time corresponds with the seed media.

In addition to the temporal reference also spatial reference of the seed media with respect to the higher quality media may be determined. This may be done with the help of visual content registration to determine the camera pose estimate (CPE) of the seed media with respect to the higher quality media. The higher quality media stream with the camera pose estimate that most closely matches the camera pose estimate of the seed media may be chosen as the substantially representative high quality media stream.

When the spatio-temporal references have been obtained, they may be used to extract the higher quality media from the corresponding higher quality media stream. Information on the location of the extracted higher quality media may be provided to the requesting capturing device 920, wherein the capturing device 920 may use this location information to download the media. As an example of the information on the location of the extracted media a link in the form of the uniform resource locator URL may be used to make the high quality representation of the seed media available for the user.

In an embodiment the extracted higher quality media may be transmitted to the capturing device 920 without first providing information on the location to the capturing device 920.

In some embodiments the user may provide a link to the service for receiving the amplified version of the original media. For example, the user may provide a media URL (e.g. a video URL from the user's Facebook page) wherein the service may transmit the extracted media to the link provided. Thus, the extracted media may also be available to friends of the user. In an embodiment the user may send information on the link to other users which s/he wants to have a look at the extracted media.

In an embodiment the system may be implemented for live streaming of amplified video content. In other words, the user may send the seed media to the media amplification server while participating the event and the media amplification server may search the higher quality media from different camera poses in real time. Also the extracted higher quality media may be transmitted to the user's capturing device as soon as possible so that the user may be able to watch the extracted media almost in real time. The user may also instruct the media amplification server to send the extracted media to another user's device wherein the other user is provided the possibility to follow the event at her/his location.

In another embodiment the system is implemented to receive the seed media after it has been recorded, wherein also the extracted higher quality media presentation is not a real time presentation.

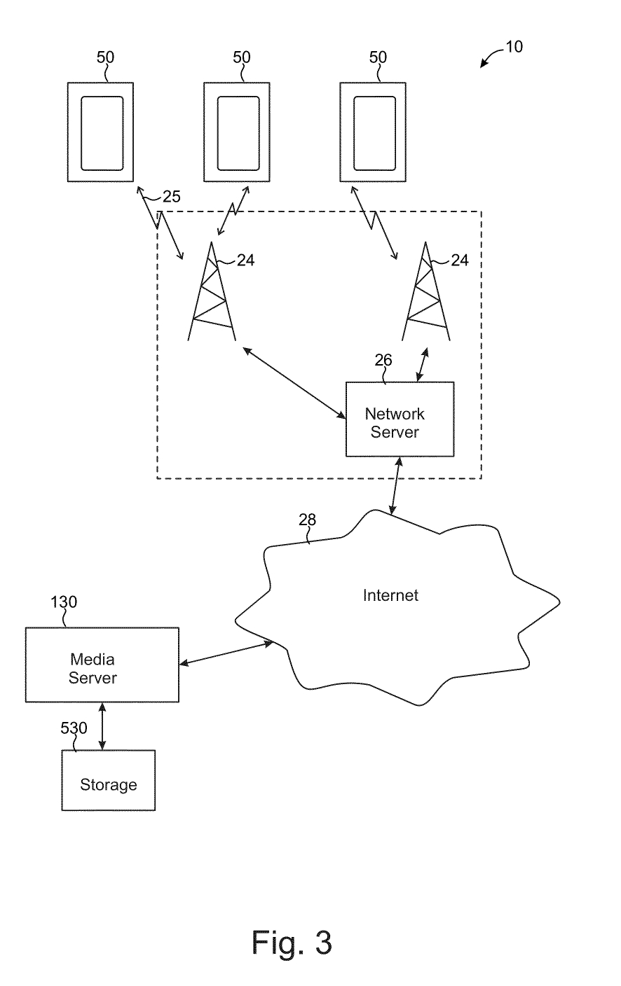

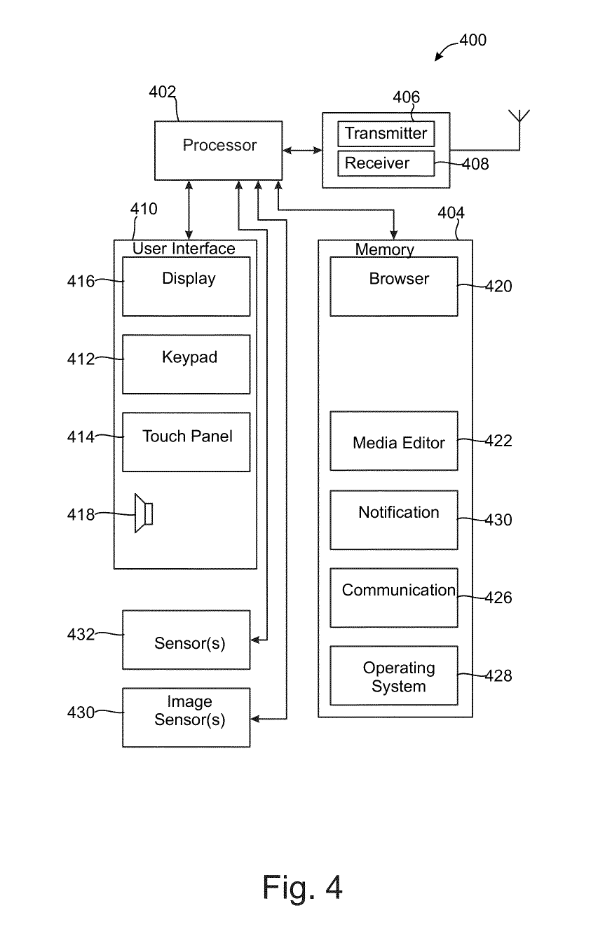

FIG. 4 depicts an example of some details of an apparatus 400 which can be used in an end user device 920. The apparatus 400 comprises a processor 402 for controlling at least some of the operations of the apparatus 400, and a memory 404 for storing user data, computer program instructions, possible parameters, registers and/or other data. The apparatus 400 may further comprise a transmitter 406 and a receiver 408 for communicating with other devices and/or a wireless communication network e.g. via a base station 24 of the wireless communication network an example of which is depicted in FIG. 3. The apparatus 400 may also be equipped with a user interface 410 (UI) to enable the user of the apparatus 400 to enter commands, input data and dial a phone number, for example. For this purpose the user interface 410 may comprise a keypad 412, a touch sensitive element 414 and/or some other kinds of actuators. The user interface may also be used to provide the user some information in visual and/or in audible form e.g. by a display 416 and/or a loudspeaker 418. If the user interface 410 comprises the touch sensitive element 414, it may be positioned so that it is at least partly in front of the display 416 so that the display 416 can be used to present e.g. some information through the touch sensitive element 414 and the user can touch the touch sensitive element 414 at the location where the information is presented on the display 416. The touch and the location of the touch may be detected by the touch sensitive element 414 and information on the touch and the location of the touch may be provided by the touch sensitive element 414 to the processor 402, for example. For this purpose, the touch sensitive element 414 may be equipped with a controller (not shown) which detects the signals generated by the touch sensitive element and deduces when a touch occurs and the location of the touch. In some other embodiments the touch sensitive element 414 provides some data regarding the location of the touch to the processor 402 wherein the processor 402 may use this data to determine the location of the touch. The combination of the touch sensitive element 414 and the display 416 may also be called as a touch screen.

In some embodiments the keypad 412 may be implemented without dedicated keys or keypads or the like e.g. by utilizing the touch sensitive element 414 and the display 416. For example, in a situation in which the user of the device is requested to enter some information, such as a telephone number, her/his personal identification number (PIN), a password etc., the corresponding keys (e.g. alphanumerical keys or telephone number dialing keys) may be shown by the display 416 and the touch sensitive element 414 may be operated to recognize which keys the user presses. Furthermore, although the keypad 412 would be implemented in this way, in some embodiments there may still exist one or more keys for specific purposes such as a power switch etc.

The user interface can be implemented in many different ways wherein the details of the operation of the user interface 410 may vary. For example, the user interface 410 may be implemented without the touch sensitive element wherein the keypad may be used to inform the apparatus 400 to start a browser, to start sending a seed media, to inform the user of available content for the seed media, selection of preferences for scene synthesis, etc.

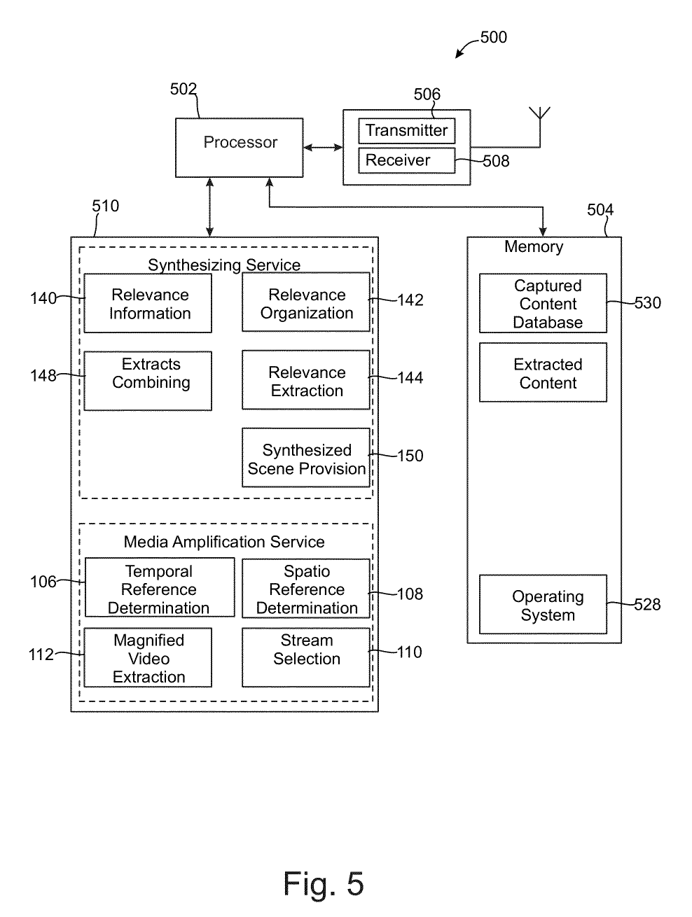

FIG. 5 depicts an example of some details of an apparatus 500 which can be used in a media server 130. The apparatus 500 comprises a processor 502 for controlling at least some of the operations of the apparatus 500, and a memory 504 for storing user data, computer program instructions, possible parameters, registers and/or other data. The apparatus 500 may further comprise a transmitter 506 and a receiver 508 for communicating with other devices and/or a communication network e.g. via a base station 24 of the wireless communication network.

The apparatus 500 may also comprise some functionalities 510 for implementing the scene synthesis and/or media amplification. The functionalities relating to the scene synthesis may include, for example, the relevance information extraction service 140, the relevance information organizing and storing service 142, the content extraction service 144, the extracted content storage service 146, the extracts combining service 148, and the synthesized scene providing service 150. The functionalities relating to the media amplification may include, for example, the temporal reference determination service 106, the spatial reference determination service 108, the spatio-temporal reference selection service 110, and the magnified video extraction service 112.

The memory 504 of the apparatus 500 may also comprise a captured content database 530 but it may also be external to the apparatus. Furthermore, the captured content database 530 need not be stored in one location but may be constructed in such a way that different parts of the captured content database 530 are stored in different locations in a network, e.g. in different servers.

The apparatuses 400, 500 may comprise groups of computer instructions (a.k.a. computer programs or software) for different kinds of operations to be executed by the processor 402, 502. Such groups of instructions may include instructions by which a camera application controls the operation of the image sensor 430 and displays information captured by the image sensor 430 on the display of the user device 920, displays a user interface for defining a seed media and preferences, forms a request for scene synthesis or media amplification, etc. In the server the software may include groups of instructions for obtaining captured content, examining seed media, preferences and captured content, and forming a synthesized scene or higher quality media, transmit the synthesized scene or the higher quality media to user devices, etc.

The apparatuses 400, 500 may also comprise an operating system (OS) 428, 528, which is also a package of groups of computer instructions and may be used as a basic element in controlling the operation of the apparatus. Hence, the starting and stopping of applications, services and other computer programs, changing status of them, assigning processor time for them etc. may be controlled by the operating system. Description of further details of actual implementations and operating principles of computer software and operating systems is not necessary in this context.

The user device may be operable as a mobile phone, a computer such as a laptop computer, a desktop computer, a tablet computer etc. and may also be provided with local (short range) wireless communication means, such as Bluetooth™ communication means, near field communication means (Nfc), communication means for communicating with a wired communication network and/or communication means for communicating with a wireless local area network (WLAN).

In this context the short range wireless communication may mean communication within a distance (range) of a few centimetres, a few meters, ten meters, some tenths of meters, hundreds of meters or even some kilometres. It should also be noticed that the actual range need not be accurate or symmetrical to each direction but may vary depending e.g. on possible obstacles between a source device and a user device, radiating properties of the antenna of the source device and the user device etc.

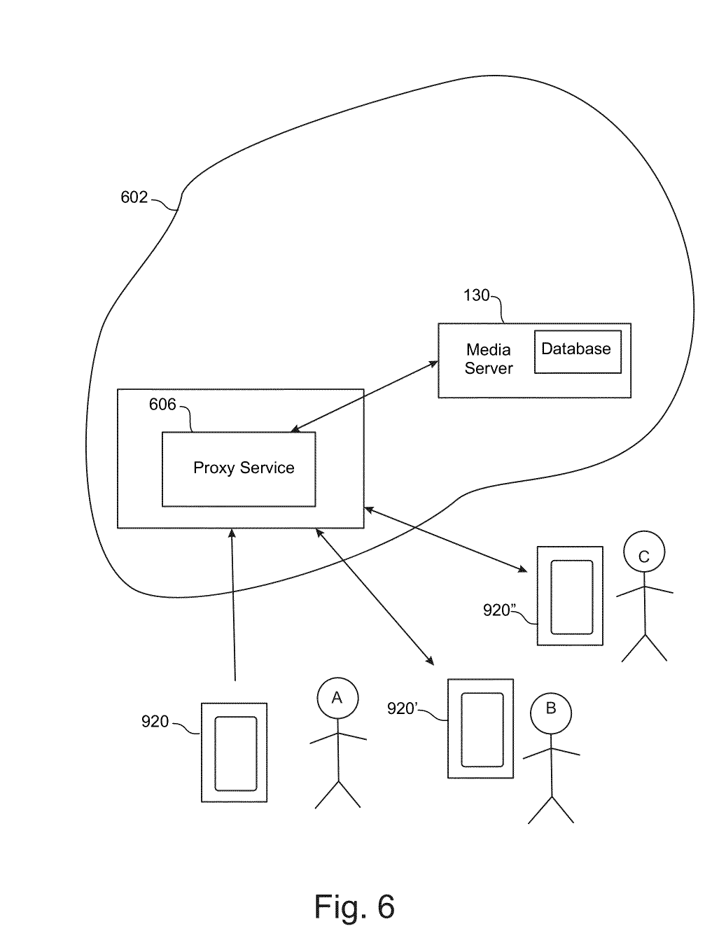

In the following, some non-limiting example situations in which the invention may be used are described in more detail. In a first example, as depicted in FIG. 6, some friends A, B, C are within a certain area, e.g. in the same room. They all may have a device 920, 920′, 920″ which is capable of capturing images, video and/or audio. The event the friends are attending may, for example, be a birthday party. User A may capture by her/his device a video of cutting a cake and the user B may capture by her/his device a video from another viewpoint and possibly of another situation occurring during the birthday party. The user C may also use her/his device to capture some media clips of the event, such as record an audio clip during the event and/or capture images from her/his viewpoint. The captured/recorded images, video and audio may also be called as media clips in this context but the term media clip is not to be interpreted narrowly to mean only such short clips captured during an event. The users A, B and/or C may send (upload) the captured media clips to a server 510 e.g. via a wireless communication network. The media clips may then be stored by the server 510 together with some meta information relating to the media clips. The meta information may include e.g. time of the capturing of the media clip, information on the location where the media clip was captured, information on the identity of the device and/or the user of the device which captured the media clip, information on the type of the media clip, information describing the event where the media clip was captured (information relating to the context of the event), information inserted by the user to describe the contents of the media clip, etc. It should be noted here that the event may be any kind of a situation in which media may be captured. The event may be an organized event such as a concert, a theatre, a party, or it may relate to an occasional event such as walking on a street, visiting a city, a holiday trip, etc.

The media clips may be segmented by dividing the media clips into one or more segments each containing one or more parts of the media clips, such as frames and/or images. The segmentation may be based on the content of the image. For example, if the user captures multiple video clips during an event and sends them either separately or together to the server, the user device or the server may combine the video clips into a media file in which each video clip may form one segment. However, there may also be other criteria for the segmentation such as location, time, background sounds, the amount of ambient light, etc. In some embodiments the background sounds recorded by the user device during the capture of a video may include music played at the event wherein when the music track changes the server may conclude that a new segment could be started, wherein the next part of the video could be included in a new segment. In some embodiments the segmentation may also be based on scene cuts in a video presentation, wherein when there is a significant change between two successive frames of the video presentation it may be concluded that the current segment should end and a new segment should begin.

The media clips may also be constructed by the user, wherein the user may conclude the segmentation during the media clip construction process, or the segmentation may still be performed by analysing the content of the media clip. For example, the user may collect different video clips, images and/or audio clips and combine them as a new media clip. The construction may be performed e.g. by using a media editor 422, a browser or another application which is appropriate for this purpose.

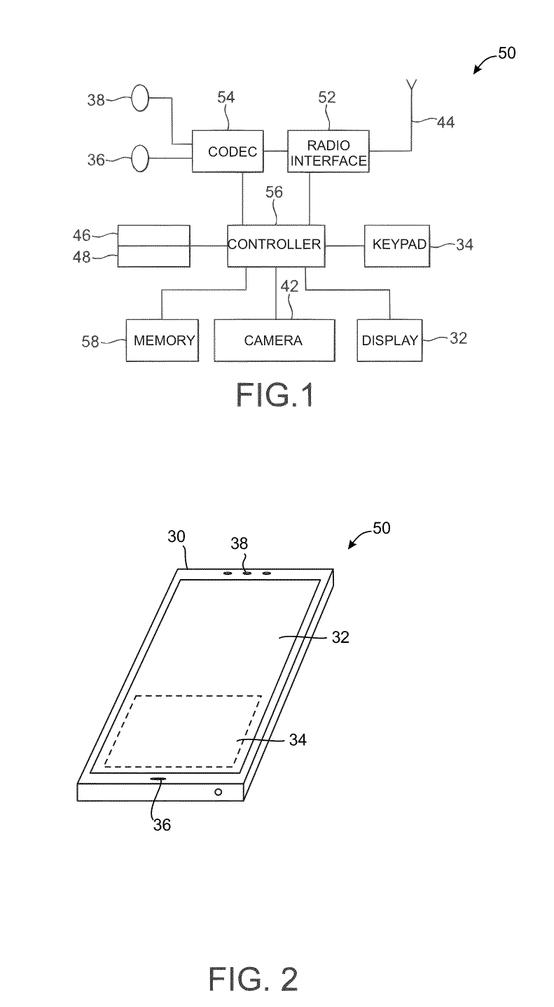

The following describes in further detail suitable apparatus and possible mechanisms for implementing the embodiments of the invention. In this regard reference is first made to FIG. 1 which shows a schematic block diagram of an exemplary apparatus or electronic device 50 depicted in FIG. 2, which may incorporate content delivery functionality according to some embodiments of the invention.

The electronic device 50 may for example be a mobile terminal or user equipment of a wireless communication system. However, it would be appreciated that embodiments of the invention may be implemented within any electronic device or apparatus which may utilize content delivery operations, either by setting content available for delivery and transmitting the content and/or by receiving the content.

The apparatus 50 may comprise a housing 30 for incorporating and protecting the device. The apparatus 50 may further comprise a display 32 e.g. in the form of a liquid crystal display, a light emitting diode (LED) display, an organic light emitting diode (OLED) display. In other embodiments of the invention the display may be any suitable display technology suitable to display information. The apparatus 50 may further comprise a keypad 34, which may be implemented by using keys or by using a touch screen of the electronic device. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (not shown) (or in other embodiments of the invention the device may be powered by any suitable mobile energy device such as solar cell, fuel cell or clockwork generator).

The apparatus may further comprise a camera capable of recording or capturing images and/or video. In some embodiments the apparatus 50 may further comprise any suitable short range communication solution such as for example a Bluetooth wireless connection or a USB/firewire wired connection or an infrared port for short range line of sight optical connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise one or more radio interface circuitries 52 connected to the controller and suitable for generating wireless communication signals for example for communication with a cellular communications network, a wireless communications system or a wireless local area network and/or with devices utilizing e.g. Bluetooth™ technology. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone, a PDA, an integrated messaging device (IMD), a desktop computer, a notebook computer, a laptop computer, a tablet computer, etc. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Although the above examples describe embodiments of the invention operating within an apparatus within an electronic device, it would be appreciated that the invention as described below may be implemented as part of any apparatus comprising a processor or similar element. Thus, for example, embodiments of the invention may be implemented in a wireless communication device. In some embodiments of the invention the apparatus need not comprise the communication means but may comprise an interface to input and output data to communication means external to the apparatus. As an example, the touch and share operations or part of them may be implemented in a software of a tablet computer, which may be connected to e.g. a Bluetooth adapter which contains means for enabling short range communication with other devices in the proximity supporting Bluetooth communication technology. As another example, the apparatus may be connected with a mobile phone to enable communication with other devices e.g. in the cloud model.

It shall be appreciated that the term user equipment is intended to cover any suitable type of wireless communication device, such as mobile telephones, portable data processing devices or portable web browsers.

Furthermore elements of a public land mobile network (PLMN) may also comprise transceivers as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A method for an apparatus, comprising:
obtaining a media presentation as a seed media;
obtaining one or more criteria for content extraction;
examining information relating to media presentations among a set of media presentations to find out relevance information regarding at least one of the context or content of the media presentations by using the seed media and the one or more criteria; and
on the basis of the examination, extracting one or more media presentations among the set of media presentations corresponding with the one or more criteria.

2. A method according to claim 1, wherein the one or more criteria comprises one or more of the following:
one or more visual objects of interests in the seed media;
one or more non-visual objects of interests in a scene of the seed media;
object of interest relevance with a social network;
object of interest relevance with previous object of interest preferences;
position in a three dimensional space of a device captured the seed media; or
object of interest appearance frequency.

3. A method according to claim 1 further comprising using the extracted media presentation to form a synthesized presentation.

4. A method according to claim 3 further comprising forming the synthesized presentation by combining two or more extracted media presentations.

5. A method according to claim 1 further comprising using the selected media presentation as a higher quality media presentation of the seed media.

6. A method according to claim 1, wherein the set of media presentations comprises media presentations captured at a same event than the seed media.

7. A method according to claim 6, wherein extracting one or more media presentations comprises:
comparing a pose estimate of a capturing device used for capturing the one or more media presentations with a pose of the seed media; and
selecting the media presentation, the pose estimate of the capturing device used for capturing the media presentation having a closest match with the pose of the seed media.

8. An apparatus comprising at least one processor and at least one memory including computer program code, the at least one memory and the computer program code configured to, with the at least one processor, cause the apparatus to perform at least the following:
obtain a media presentation as a seed media;
obtain one or more criteria for content extraction;
examine information relating to media presentations among a set of media presentations to find out relevance information regarding at least one of the context or content of the media presentations by using the seed media and the one or more criteria; and
on the basis of the examination, extract one or more media presentations among the set of media presentations corresponding with the one or more criteria.

9. An apparatus according to claim 8, said at least one memory stored with code thereon, which when executed by said at least one processor, causes the apparatus to use one or more of the following criteria:
one or more visual objects of interests in the seed media;
one or more non-visual objects of interests in a scene of the seed media;
object of interest relevance with a social network;
object of interest relevance with previous object of interest preferences;
position in a three dimensional space of a device captured the seed media; or
object of interest appearance frequency.

10. An apparatus according to claim 8, said at least one memory stored with code thereon, which when executed by said at least one processor, causes the apparatus to perform at least the following:
using the extracted media presentation to form a synthesized presentation.

11. An apparatus according to claim 10, said at least one memory stored with code thereon, which when executed by said at least one processor, causes the apparatus to perform at least the following:
forming the synthesized presentation by combining two or more extracted media presentations.

12. An apparatus according to claim 8, said at least one memory stored with code thereon, which when executed by said at least one processor, causes the apparatus to perform at least the following:
using the selected media presentation as a higher quality media presentation of the seed media.

13. An apparatus according to claim 8, said at least one memory stored with code thereon, which when executed by said at least one processor, causes the apparatus to perform said extracting one or more media presentations by:
comparing a pose estimate of a capturing device used for capturing the one or more media presentations with a pose of the seed media; and
selecting the media presentation, the pose estimate of the capturing device used for capturing the media presentation having a closest match with the pose of the seed media.

14. A computer program product including one or more sequences of one or more instructions which, when executed by one or more processors, cause an apparatus to perform at least the following:
obtain a media presentation as a seed media;
obtain one or more criteria for content extraction;
examine information relating to media presentations among a set of media presentations to find out relevance information regarding at least one of the context or content of the media presentations by using the seed media and the one or more criteria; and
on the basis of the examination, extract one or more media presentations among the set of media presentations corresponding with the one or more criteria.

15. A computer program product according to claim 14 including one or more sequences of one or more instructions which, when executed by one or more processors, cause an apparatus to use one or more of the following criteria:
one or more visual objects of interests in the seed media;
one or more non-visual objects of interests in a scene of the seed media;
object of interest relevance with a social network;
object of interest relevance with previous object of interest preferences;
position in a three dimensional space of a device captured the seed media; or
object of interest appearance frequency.

16. A computer program product according to claim 14 including one or more sequences of one or more instructions which, when executed by one or more processors, cause an apparatus to perform at least the following:
using the extracted media presentation to form a synthesized presentation.

17. A computer program product according to claim 16 including one or more sequences of one or more instructions which, when executed by one or more processors, cause an apparatus to perform at least the following:
forming the synthesized presentation by combining two or more extracted media presentations.

18. A computer program product according to claim 14 including one or more sequences of one or more instructions which, when executed by one or more processors, cause an apparatus to perform at least the following:
using the selected media presentation as a higher quality media presentation of the seed media.

19. A computer program product according to claim 14 including one or more sequences of one or more instructions which, when executed by one or more processors, cause an apparatus to perform said extracting one or more media presentations by:
comparing a pose estimate of a capturing device used for capturing the one or more media presentations with a pose of the seed media; and
selecting the media presentation, the pose estimate of the capturing device used for capturing the media presentation having a closest match with the pose of the seed media.

20. An apparatus comprising:
means for obtaining a media presentation as a seed media;
means for obtaining one or more criteria for content extraction;
means for examining information relating to media presentations among a set of media presentations to find out relevance information regarding at least one of the context or content of the media presentations by using the seed media and the one or more criteria; and
means for extracting, on the basis of the examination, one or more media presentations among the set of media presentations corresponding with the one or more criteria.
